(19) United States
(12) Patent Application Publication
(10) Pub. No.: US 2009/0135366 A1
(43) Pub. Date: May 28, 2009

(54) PDLC with thermally transferred electrode

(75) Inventor: David G. Pires, Phoenix, AZ (US)

Correspondence Address: Paul F. Wille;Cantor Colburn, LLP, 22nd Floor, 20 Church St., Hartford, CT, 06103, US

(73) Assignee: World Properties, Inc., Lincolnwood, IL (US)

(21) Appl. No.: 11/986,928

(22) Filed: Nov. 26, 2007

(51) Int. Cl. G02F 1/13; C09K 19/02

(52) U.S. Cl. 349/182; 349/187

(57) ABSTRACT

A PDLC light shutter includes a conductive layer that is thermally bonded to the shutter as an electrode. The layer can be patterned to provide light transmission even if the conductive layer is relatively opaque. A patterned electrode can be reconfigured easily for prototype or low volume production yet the method and apparatus are suitable for volume production as well. Toner powder can be used as an adhesive and the conductive layer is patterned directly from a xerographic print.

### BACKGROUND TO THE INVENTION

This invention relates to liquid crystal displays and, in particular, to a display using polymer dispersed liquid crystal (PDLC) and having an electrode that is thermally transferred to the display.

A liquid crystal display is a capacitive structure, having a dielectric (liquid crystal) between two electrodes, at least one of which is transparent. Often both electrodes are transparent and typically are made from indium tin oxide (ITO) sputtered on a transparent substrate, such as a dimensionally stable, transparent sheet of plastic. In order to provide graphics or alpha-numeric information, at least one of the electrodes is patterned. Typically, this includes screen printing a mask and etching the ITO layer. Etching is a chemical process with attendant problems, and cost, of handling and waste treatment.

Even though screen printing is a well developed technology and, therefore, relatively low in cost, there are disadvantages to screen printing. The resolution of screen printing is not as good as desired. For example, printing a fine line gap, e.g. 0.001″ wide, between conductors cannot be done reliably by screen printing adjacent conductors.

There are many uses for liquid crystal displays that require complicated patterns, e.g. instrument panels. Complicated patterns are presently obtained by patterning both the front electrode and the rear electrode of a liquid crystal display and, occasionally, by combining several liquid crystal displays into one display. Such construction is costly, particularly because the patterned electrodes must be properly registered in order to produce the desired display.

Great expense is incurred in developing a prototype panel when a patterned electrode must be changed or adjusted. It is very desirable to be able to produce prototypes, or make small production runs, inexpensively; i.e., comparable in cost with mass produced panels. Material costs and time could be saved with a system that allowed changes to be made simply and immediately. Ideally, a design could be created on a computer and a xerographic print used as the pattern for an electrode.

In the last twenty years, a particular class of materials, known as polymer dispersed liquid crystals (PDLC), has been developed for displays; e.g., see U.S. Pat. No. 4,992,201 (Pearlman). Devices using these materials operate at 60-120 volts peak-to-peak, unlike earlier liquid crystal materials that operated at much lower voltages, and provide contrast without the need for polarizers. Sometimes referred to as “optical shutters,” polymer dispersed liquid crystals have applications outside the realm of displays.

U.S. Pat. No. 6,842,170 (Akins et al.) discloses a liquid crystal display combined with an electroluminescent (EL) backlight and a touchscreen. The liquid crystal display is part of a keypad, containing a mask layer with images of the buttons on a telephone (0-9, * and #) and other control buttons. It is also disclosed that the liquid crystal display and the EL backlight can share a common substrate.

International Publication WO 2005/121878 discloses a liquid crystal display and an EL backlight on the same side of a substrate. Other permutations are known in the art, with devices on opposite sides of a substrate; e.g., see U.S. Pat. Nos. 5,121,234 (Kucera) and 6,441,551 (Abe et al.). Various interlayers or outer layers for affecting optical performance, e.g. color, reflectance, and dispersion, are also known in the art.

EL devices are not the only devices suitable for backlighting liquid crystal displays. Light guides coupled to various light sources are known in the art; e.g. Published application 2006/0254894 (Jung et al.) discloses a light guide edge lit by a light emitting diode and having features in the light guide for scattering light out of the plane of the light guide. A difficulty with the light guide is the inability to change output once the backlight is constructed. For example, a light guide can provide reasonably uniform lighting over an area or use features to extract light for illuminating selected areas aligned with the features. In either case, the result is fixed and change is costly.

The choice of a technology for a particular display is a balance of competing interests, not the least of which is cost. In the case of cellular telephones, the choice is often based on the presumption that the user will be indoors or at least not in direct sunlight when the telephone is used. In other words, the content of the display all but vanishes in bright light because the display relies on luminous backlighting for visibility. Many liquid crystal displays rely on reflective backlighting. Thus, the backlighting increases or decreases with ambient light and the content of the display remains visible. Some displays try for the best of both worlds with a “transflective” layer between a backlight and a liquid crystal module.

It is known in the art to provide a liquid crystal display including PDLC and a reflective rear electrode of aluminum; e.g. see U.S. Pat. No. 6,825,895 (Nakano et al.). It is known in the art to use a plurality of thermal pins in an array for printing; e.g. see U.S. Pat. No. 3,855,448 (Hanagata et al.). It is also known in the art to thermally print electrically conductive carbon black from a ribbon; e.g. see U.S. Pat. No. 4,269,892 (Shattuck et al.).

In view of the foregoing, it is therefore an object of the invention to provide a PDLC light shutter in which one electrode is thermally bonded to the shutter.

Another object of the invention is to provide a PDLC light shutter in which an electrode is thermally bonded to the light shutter.

A further object of the invention is to provide a PDLC light shutter in which a patterned electrode is thermally bonded to the light shutter.

Another object of the invention is to provide a PDLC light shutter in which a patterned electrode can be changed easily for prototype or low volume production.

A further object of the invention is to provide a PDLC light shutter in which an electrode is thermally bonded by toner powder.

Another object of the invention is to provide a PDLC light shutter having an electrode that is patterned directly from a xerographic print.

### SUMMARY OF THE INVENTION

The foregoing objects are achieved by the invention in which a PDLC light shutter includes a conductive layer that is thermally bonded to the shutter as an electrode. The layer can be patterned to provide light transmission even when the conductive layer is relatively opaque. A patterned electrode can be reconfigured easily for prototype or low volume production yet the method and apparatus are suitable for volume production as well. Toner powder can be used as an adhesive and the conductive layer is patterned directly from a xerographic print.

### BRIEF DESCRIPTION OF THE DRAWINGS

A more complete understanding of the invention can be obtained by considering the following detailed description in conjunction with the accompanying drawings, in which:

FIG. 1 illustrates a ribbon having a thermally transferable conductive layer;

FIG. 2 illustrates, in cross-section, a method for bonding a conductive layer to a PDLC light shutter;

FIG. 3 illustrates, in cross-section, a method for bonding a conductive layer to a PDLC light shutter using toner powder as adhesive;

FIG. 4 illustrates, in cross-section, another method for bonding a conductive layer to a PDLC light shutter using toner powder as adhesive;

FIG. 5 illustrates bonding an electrode with the adhesive on the electrode;

FIG. 6 illustrates a display constructed in accordance with a preferred embodiment of the invention;

FIG. 7 illustrates a display constructed in accordance with an alternative embodiment of the invention; and

FIG. 8 is a plan view of an electrode constructed using a thermally adhered conductive layer having apertures for light transmission.

### DETAILED DESCRIPTION OF THE INVENTION

FIG. 1 illustrates a ribbon having a thermally transferable conductive layer. Ribbon 10 is flexible but dimensionally stable and preferably includes registration guides, illustrated as sprocket holes 11 and 12. The registration guides can be optical rather than mechanical. The dimensions of the ribbon are determined by the intended use. In accordance with one aspect of this invention, wherein toner powder is used as an adhesive, the ribbon can be a standard size sheet of paper to facilitate handling by a xerographic printer. The printer can print fiduciary marks as registration guides at the same time that the pattern for the conductive layer is printed.

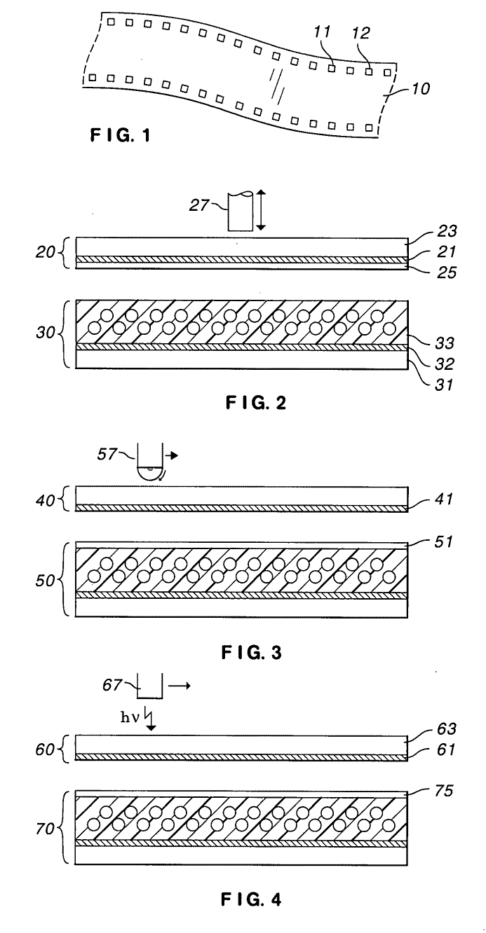

FIG. 2 illustrates a preferred method for bonding a conductive layer to a PDLC light shutter. In this embodiment of the invention, ribbon 20 includes conductive layer 21 overlying substrate 23 and adhesive layer 25 overlying the conductive layer. Conductive layer 21 is attached to substrate 23 by a release coat (not shown) that has the characteristic of being less adhesive than adhesive layer 25. Thus, when layer 25 is softened or activated by heat, conductive layer 21 will separate from substrate 23. Conductive layer 21 is a thin (on the order of thousands of angstroms) layer of metal.

Light shutter 30 include substrate 31, transparent conductor 32, and PDLC layer 33. The light shutter can be deposited by screen printing or other method, such as roll coating. With substrate 31 operating roll to roll and being roll coated and with ribbon 10 operating roll to roll, light shutters can be produced in considerable volume, yet have custom patterns.

Ribbon 20 and light shutter 30 are illustrated in FIG. 2 as slightly spaced for clarity. For transfer, the two are brought together and heated pin 27 is brought down to transfer a portion of conductive layer 21 to light shutter 30. Pin 27 is one of a plurality of pins, somewhat like in a dot matrix printer. The combination of heat and pressure effect the transfer. The pins can be actuated individually, thereby controlling the resulting pattern in conductive layer 21 when it adheres to light shutter 30. The resolution of the pattern depends upon the diameter of the pins, which can be quite small; e.g. 0.005″.

FIG. 3 illustrates a method for bonding a conductive layer to a PDLC light shutter using toner powder as adhesive. In this embodiment, ribbon 40 is constructed in the same manner as ribbon 20. Patterned layer 51 of toner powder is applied to EL light shutter 50, e.g. by printing on a separate sheet and laminating the sheet to the light shutter or by printing on the light shutter. For transfer, ribbon 40 brought into contact with patterned layer 51 and heated roller 57 is brought down to transfer a portion of conductive layer 41 to light shutter 50. Heated roller need not be the same width (dimension into the drawing) as light shutter 50 but preferably is the same width or wider than light shutter 50.

FIG. 4 illustrates another method for bonding a conductive layer to a PDLC light shutter using toner powder as adhesive. In this embodiment, ribbon 60 includes conductive layer 61 overlying substrate 63 and thermally activated adhesive layer 65 overlying the conductive layer. Adhesive layer 75 is the uppermost layer in light shutter 70.

For transfer, ribbon 60 brought into contact with light shutter 70 and transient heating is effected without pressure by laser 67, which scans the light shutter, preferably in a raster pattern. In FIG. 5, ribbon 81 is brought into contact with light shutter 82, which does not include an adhesive layer. In FIGS. 2, 3, 4, and 5, the adhesive layer on the conductor can be patterned and formed xerographically; i.e. the adhesive is toner. Transfer softens the adhesive, causing the toner and the conductive layer to adhere to the light shutter.

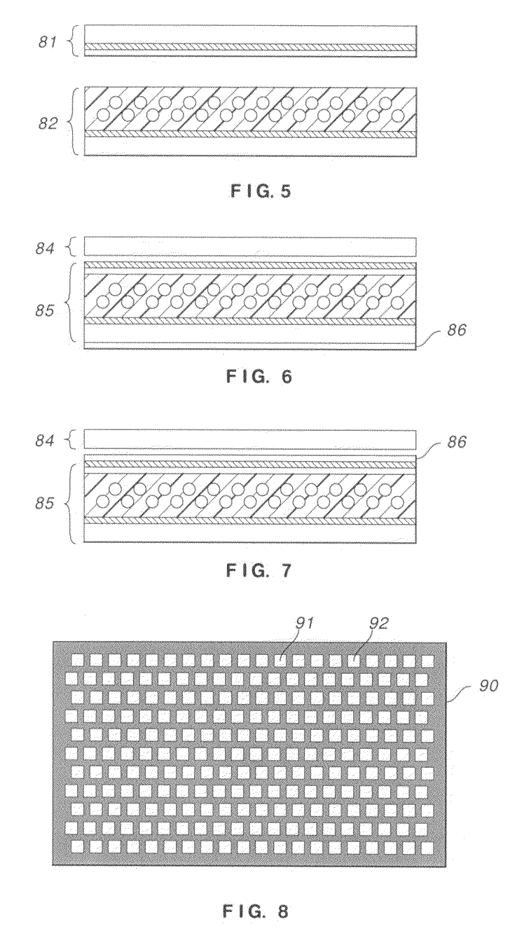

FIG. 6 is a cross-section of a display constructed in accordance with a preferred embodiment of the invention. Light source 84 overlies light shutter 85. Graphic layer 86 is illuminated by light source 84 through light shutter 85. Light source 84 can be an electroluminescent sheet or a light guide. Graphic layer 86 is preferably on the opposite side of light shutter 85 from light source 84 for visual clarity. In this arrangement, light shutter 85 obscures light from light source 84. The elements can be re-arranged to place graphics layer 86 between light source 84 and shutter 85, as shown in FIG. 7. In either case, a light scattering layer, such as barium titanate in a suitable resin, can be included in the light shutter.

Unless extremely thin, a metallic film is relatively opaque. In many circumstances, this problem can be overcome by including apertures in the metallic film. As illustrated in FIG. 8, electrode 90 is a metallic film that includes a plurality of apertures, such as apertures 91 and 92. The shape of the apertures is not critical, the apertures can be any closed curve or any polyhedron. The location of the apertures is not critical; that is, the apertures need not be arranged in an ordered pattern as illustrated. The arrangement can be irregular or graduated; see U.S. Pat. Nos. 5,550,676 (Ohe et al.), 5,477,422 (Hooker et al.) and 6,386,721 (Hosseini et al.). The apertures need not have the same area as each other. Despite the apertures, electrode 90 functions as an electrode and, if made from aluminum, for example, also functions as a reflector.

The invention thus provides a liquid crystal display in which the an electrode is thermally bonded to the light shutter. A patterned electrode can be changed easily for prototype or low volume production yet the method and apparatus are suitable for volume production as well. Toner powder can be used as an adhesive and the electrode can be patterned directly from a xerographic print. With apertures, an electrode can be the front electrode, the rear electrode, or both electrodes. Information can be displayed by the shape of the pattern on the electrodes of the light shutter or by a separate graphic sheet.

Having thus described the invention, it will be apparent to those of skill in the art that various modifications can be made within the scope of the invention. For example, a hot platen laminator can be used instead of heated rollers when transferring a patterned toner powder. The bond between layers can be enhanced by treating a layer with an adhesion promoter; e.g. applying a thin coating of solvent to the upper surface of PDLC layer 33 rather than using an adhesive layer. Although raster scanning is preferred, other techniques can be used instead; e.g. vector plotting. A light shutter constructed in accordance with the invention, combined with a light source and a graphics layer, provides a low cost display.

What is claimed as the invention is:

1. A light shutter including polymer dispersed liquid crystal material characterized in that the shutter includes a conductive layer thermally transferred to the shutter and a layer of adhesive between the conductive layer and the polymer dispersed liquid crystal material, wherein the conductive layer is at least a portion of an electrode of said shutter and the adhesive is thermally activated to attach the conductive layer to the polymer dispersed liquid crystal material.

2. The shutter as set forth in claim 1 wherein the adhesive softens when heated.

3. The shutter as set forth in claim 1 wherein said conductive layer is patterned.

4. The shutter as set forth in claim 3 wherein the pattern includes a plurality of apertures.

5. The shutter as set forth in claim 1 wherein said adhesive includes toner for xerographic printing.

6. A method for applying an electrode to a PDLC light shutter, said method comprising the steps of:
contacting the light shutter with a conductive layer and an adhesive;
selectively applying localized heat to the adhesive, causing the conductive layer to adhere to said light shutter, forming said electrode.

7. The method as set forth in claim 6 wherein said adhesive is on the light shutter.

8. The method as set forth in claim 7 wherein said adhesive is on the conductive layer, between the conductive layer and the light shutter.

9. The method as set forth in claim 7 wherein said heat is applied by laser.

10. The method as set forth in claim 7 wherein said heat is applied by heated pin.
